(19) United States
(12) Patent Application Publication
(10) Pub. No.: US 2011/0201215 A1
(43) Pub. Date: Aug. 18, 2011

(54) RECEPTACLE, PRINTED WIRING BOARD, AND ELECTRONIC DEVICE

(75) Inventors: Ryo Matsubara, Osaka (JP); Shouichi Mimura, Osaka (JP); Hirotsugu Fusayasu, kyoto (JP); Masafumi Kumoi, Osaka (JP); Toshiyuki Nakaie, Osaka (JP)

(73) Assignee: Panasonic Corporation, Kadoma-shi, Osaka (JP)

(21) Appl. No.: 12/936,907

(22) PCT Filed: Apr. 8, 2010
(86) PCT No.: PCT/JP2010/002584

§ 371 Date: Oct. 7, 2010

(30) Foreign Application Priority Data
Feb. 18, 2010 (JP) 2010-033992

(51) Int. Cl. H01R 12/70; H01R 24/00

(52) U.S. Cl. 439/55; 439/660

(57) ABSTRACT

In a receptacle, a ground terminal includes a bottom face connection portion connected to a bottom face of a terminal insulating board and a forward connection portion that is distanced from an opening. A signal terminal includes a top face connection portion connected to a top face on the opposite side of the bottom face connection portion and a rearward connection portion that is provided closer to the opening than the forward connection portion.

### TECHNICAL FIELD

The present invention relates to receptacles, printed wiring boards, and to electronic devices that include a receptacle and a printed wiring board.

### BACKGROUND ART

Techniques in which digital signals are transmitted at high speeds between electronic devices (for example, A/V devices, mobile terminals, and so on) via interfaces based on standards such as HDMI (High-Definition Multimedia Interface)®, USB (Universal Serial Bus), and so on have come into wide use in recent years.

Such interfaces are configured of a receptacle mounted on a mounting face of a printed wiring board and a plug that is inserted into the receptacle.

The receptacle includes a terminal insulating board that fits into the plug, multiple bottom terminals, and multiple top terminals. The terminal insulating board has a bottom face provided on the side toward the printed wiring board and a top face provided on the opposite side of the bottom face. Each of the bottom terminals is connected to the bottom face of the terminal insulating board and the printed wiring board. Each of the top terminals, meanwhile, is connected to the top face of the terminal insulating board and the printed wiring board.

Here, the locations at which the top terminals are connected to the printed wiring board are normally distanced further from the terminal insulating board than the locations at which the bottom terminals are connected to the printer circuit board in order to simplify the terminal structure (for example, see JP2009-9728A). Accordingly, the top terminals are longer than the bottom terminals.

### SUMMARY

Incidentally, there are cases where there is a signal terminal for transmitting digital signals in the multiple top terminals and a ground terminal corresponding to the signal terminal in the multiple bottom terminals. In such a case, it is easy to ensure noise resistance by using ground wires formed in the substrate (this includes the printed wiring board and the terminal insulating board) at both ends of the signal terminal. However, because there is a limit to how many ground terminals can be run parallel to each other, it is difficult to ensure noise resistance in the central portion of the signal terminal. It is thus desirable for the length of the central portion of the signal terminal to be short.

However, with the stated terminal structure, it is necessary to form the top terminals so as to be longer than the bottom terminals. There is thus a problem in that it is difficult to improve the noise resistance of the signal terminal in the multiple top terminals.

Having been conceived in light of the aforementioned problem, it is an object of the present invention to provide a receptacle, a printed wiring board, and an electronic device capable of improving the noise resistance of a signal terminal in multiple top terminals.

A receptacle according to an aspect of the present invention includes: a housing configured to be mounted on a printed wiring board, including an opening into which a plug is inserted; a terminal insulating board including a top face and a bottom face opposite the top face, the terminal insulating board being disposed inside the housing with the bottom face facing the printed wiring board; a ground terminal including a bottom face connection portion connected to the bottom face and a forward connection portion connected to the printed wiring board; and a signal terminal including a top face connection portion connected to the top face on the opposite side of the bottom face connection portion and a rearward connection portion connected to the printed wiring board closer to the opening than the forward connection portion.

A printed wiring board according to an aspect of the present invention includes: a main substrate including a mounting face configured to support the receptacle, and being disposed on the bottom face of the terminal insulating board; a ground terminal land disposed on the mounting face, and connected to the ground terminal; and a signal terminal land disposed on the mounting face closer to an edge of the main substrate than the ground terminal land, and connected to the signal terminal.

An electronic device according to an aspect of the present invention includes a receptacle and a printed wiring board. The receptacle has: a housing configured to be mounted on a printed wiring board, including an opening into which a plug is inserted; a terminal insulating board including a top face and a bottom face opposite the top face, the terminal insulating board being disposed inside the housing with the bottom face facing the printed wiring board; a ground terminal including a bottom face connection portion connected to the bottom face and a forward connection portion connected to the printed wiring board; and a signal terminal including a top face connection portion connected to the top face on the opposite side of the bottom face connection portion and a rearward connection portion connected to the printed wiring board. The printed wiring board has: a printed wiring board having: a main substrate including a mounting face configured to support the receptacle, and being disposed on the bottom face of the terminal insulating board; a ground terminal land disposed on the mounting face, and connected to the rearward connection portion; and a signal terminal land disposed on the mounting face closer to an edge of the main substrate than the ground terminal land, and connected to the rearward connection portion.

According to the present invention, it is possible to provide a receptacle, a printed wiring board, and an electronic device capable of improving the noise resistance of a signal terminal in multiple top terminals.

### BRIEF DESCRIPTION OF DRAWINGS

FIG. 1 is a perspective view illustrating the configuration of an interface 10 according to a first embodiment;

FIG. 2 is a plan view illustrating a receptacle 12 according to the first embodiment as viewed from an opening 12B;

FIG. 3 is a perspective view illustrating the internal configuration of the receptacle 12 according to the first embodiment;

FIG. 4 is a plan view illustrating a printed wiring board 11 according to the first embodiment as viewed from a mounting face F_{MNT};

FIG. 5 is a perspective view illustrating a ground terminal T_{G2} and a pair of signal terminals T_{S2+} and T_{S2-} according to the first embodiment;

FIG. 6 is a side view illustrating the ground terminal T_{G2} and the pair of signal terminals T_{S2+} and T_{S2-} according to the first embodiment;

FIG. 7 is a perspective view illustrating a ground terminal T_{G0} and a pair of signal terminals T_{S0+} and T_{S0-} according to the first embodiment;

FIG. 8 is a side view illustrating the ground terminal T_{G0} and the pair of signal terminals T_{S0+} and T_{S0-} according to the first embodiment;

FIG. 9 is a perspective view illustrating a ground terminal T_{G2} and a pair of signal terminals T_{S2+} and T_{S2-} according to a second embodiment;

FIG. 10 is a plan view illustrating the ground terminal T_{G2} and the pair of signal terminals T_{S2+} and T_{S2-} according to the second embodiment;

FIG. 11 is a side view illustrating the ground terminal T_{G2} and the pair of signal terminals T_{S2+} and T_{S2-} according to the second embodiment;

FIG. 12 is a perspective view illustrating a receptacle 12 according to a third embodiment as viewed from a top face F_{TOP};

FIG. 13 is a perspective view illustrating the receptacle 12 according to the third embodiment as viewed from a bottom face F_{BTM};

FIG. 14 is a transparent view illustrating a ten signal insulating board 12C according to the third embodiment as viewed from the top face F_{TOP}; and

FIG. 15 is a see-through perspective view of the terminal insulating board 12C illustrating the configuration of a ground terminal T_{G2} and a signal terminal T_{S2-} according to the third embodiment.

### DETAILED DESCRIPTION OF THE EMBODIMENTS

Next, embodiments of the present invention will be described using the drawings. In the following descriptions of the drawings, identical or similar elements will be given identical or similar reference numerals. However, the drawings are schematic in nature and thus there are cases where the illustrated ratios of dimensions and so on differ from the actual ratios. As such, the specific dimensions should be judged in consideration of the following descriptions. Furthermore, it goes without saying that the drawings include elements whose dimensional relationships, ratios, and so on differ from drawing to drawing.

### (Configuration of Interface 10)

The configuration of an interface 10 according to a first embodiment will be described with reference to the drawings. The present embodiment will describe the interface 10, based on the HDMI (High-Definition Multimedia Interface)® standard, as an example of an interface between electronic devices. Note that “electronic device” refers to, for example, an A/V device, a mobile terminal, a personal computer, or the like.

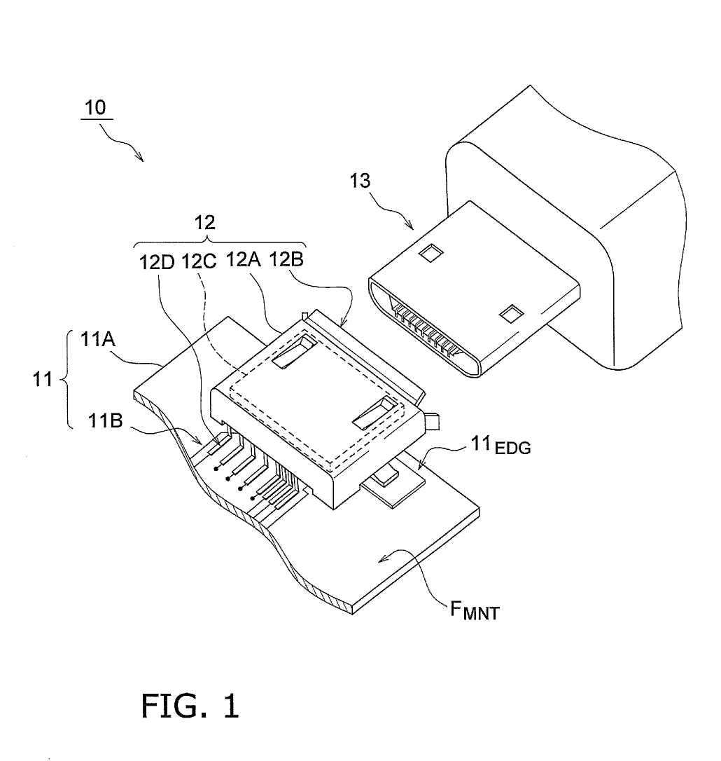

FIG. 1 is a perspective view illustrating the configuration of the interface 10 according to the first embodiment. As shown in FIG. 1, the interface 10 is configured of a printed wiring board 11, a receptacle 12, and a plug 13.

The printed wiring board 11 is installed within a first electronic device (not shown). The printed wiring board 11 includes a main substrate 11A and a wire group 11B. The main substrate 11A has a mounting face F_{MNT}. The configuration of the printed wiring board 11 will be described later.

The receptacle 12 is mounted upon the mounting face F_{MNT} at an edge portion 11_{EDG} of the printed wiring board 11. The receptacle 12 includes a housing 12A, an opening 12B, a terminal insulating board 12C, and a terminal group 12D. The configuration of the receptacle 12 will be described later.

The plug 13 is provided in a second electronic device (not shown). The plug 13 is electrically connected to the receptacle 12 by inserting the plug 13 into the opening 12B.

The plug 13 transmits digital signals between the first electronic device and the second electronic device.

### (Receptacle Configuration)

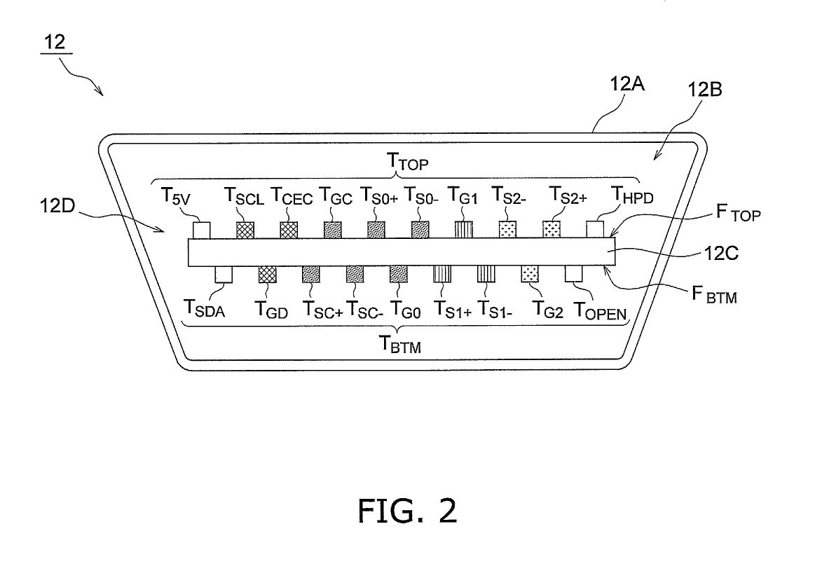

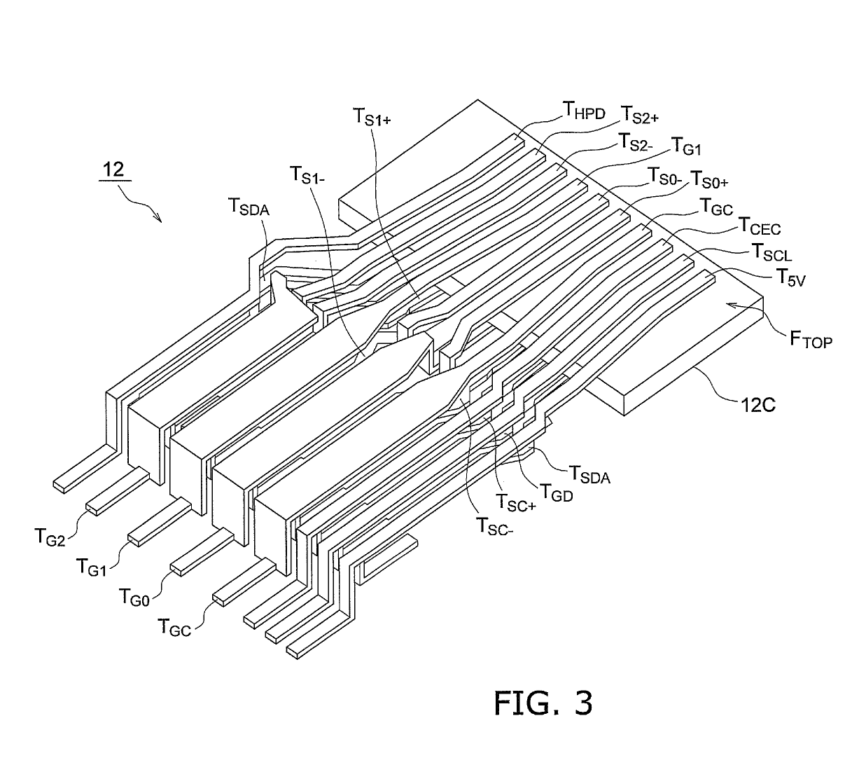

Next, the configuration of the receptacle according to the first embodiment will be described with reference to the drawings. FIG. 2 is a plan view illustrating the receptacle 12 according to the first embodiment as viewed from the opening 12B. FIG. 3 is a perspective view illustrating the internal configuration of the receptacle 12. Note that the housing 12A has been omitted from FIG. 3.

As shown in FIGS. 2 and 3, the receptacle 12 includes the housing 12A, the opening 12B, the terminal insulating board 12C, and the terminal group 12D.

The housing 12A is a container that houses the terminal group 12D, the terminal insulating board 12C, and so on.

The opening 12B is formed in the housing 12A. The plug 13 is inserted into the opening 12B. Although not shown in the drawings, the opening 12B is exposed through the housing of the first electronic device.

The terminal insulating board 12C is a plate-shaped board provided within the housing 12A. The terminal insulating board 12C is fitted into the plug 13. The terminal insulating board 12C has, as shown in FIGS. 2 and 3, a bottom face F_{BTM} and a top face F_{TOP}. The bottom face F_{BTM} is provided on the side toward the mounting face F_{MNT}. The top face Prop, meanwhile, is provided on the opposite side of the bottom face F_{BTM}.

The terminal group 12D is connected to the terminal insulating board 12C and the printed wiring board 11 (and to be more specific, to the wire group 11B). The terminal group 12D transmits digital signals between the printed wiring board 11 and the plug 13. The terminal group 12D has multiple bottom terminals T_{BTM} and multiple top terminals T_{TOP}. The bottom terminals T_{BTM} are, as shown in FIG. 2, disposed in an alternating fashion with respect to the top terminals T_{TOP}.

The multiple bottom terminals T_{BTM} include an open terminal T_{OPEN}, a ground terminal T_{G2}, a pair of signal terminals T_{S1+} and T_{S1-}, a ground terminal T_{G0}, a pair of signal terminals T_{SC+} and T_{SC-}, a ground terminal T_{GD}, and an SDA terminal T_{SDA}. Each of the bottom terminals T_{BTM} is connected to the bottom face F_{BTM} of the terminal insulating board 12C and the printed wiring board 11. The bottom terminals T_{BTM} are configured of a plate-shaped metal material that has undergone a bending process. The configurations of the ground terminal T_{G2} and the ground terminal T_{G0} will be described later.

The multiple top terminals T_{TOP} include an HPD signal terminal T_{HPD}, a pair of signal terminals T_{S2+} and T_{S2-}, a ground terminal T_{G1}, a pair of signal terminals T_{S0+} and T_{S0-}, a ground terminal T_{GC}, a CEC terminal T_{CEC}, an SCL terminal T_{SCL}, and a power source terminal T_{5V}. The top terminals T_{TOP} are configured of a plate-shaped metal material that has undergone a bending process.

Each of the multiple top terminals T_{TOP} is connected to the top face F_{TOP} of the terminal insulating board 12C and the printed wiring board 11. The configurations of the pair of signal terminals T_{S2+} and T_{S2-}. and the pair of signal terminals T_{S0+} and T_{S0-} will be described later.

Note that the signal terminals T_{S} transmit digital signals according to a quasi-differential transmission system such as TMDS (Transition Minimized Differential Signaling). As such, the phase of the digital signal transmitted by the signal terminal T_{S1+} is inverted relative to the phase of the signal transmitted by the signal terminal T_{S1-}.

Meanwhile, the ground terminals T_{G} ground corresponding signal terminals T_{S}. For example, the ground terminal T_{G1} grounds the pair of signal terminals T_{S1+} and T_{S1-}.

### (Configuration of Printed Wiring Board 11)

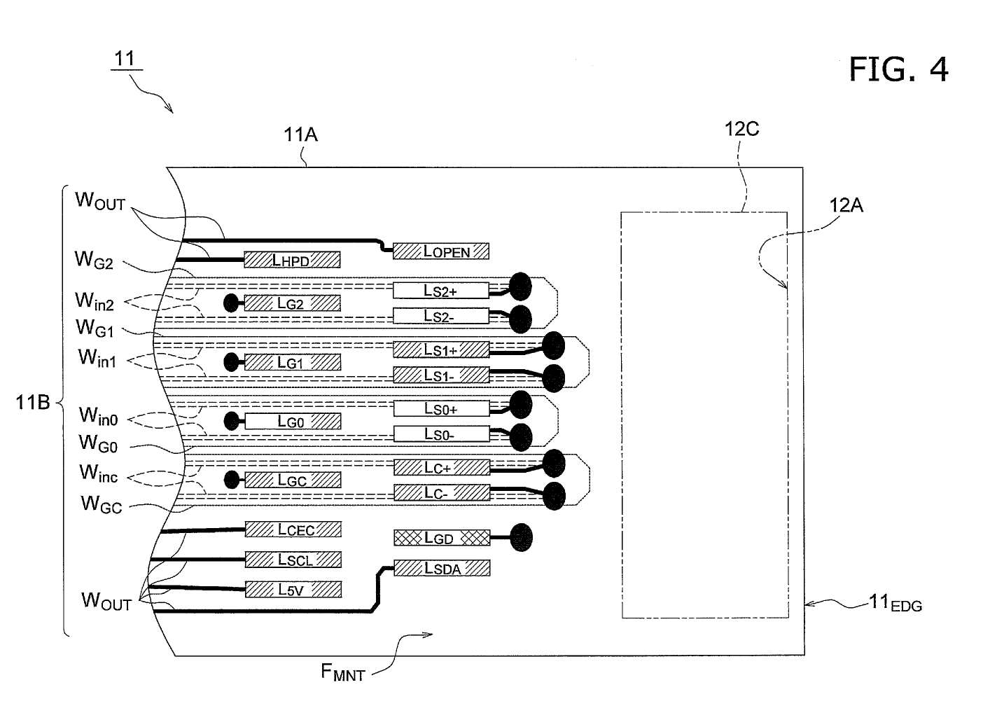

Next, the configuration of the printed wiring board 11 according to the first embodiment will be described with reference to the drawings. FIG. 4 is a plan view illustrating the printed wiring board 11 according to the first embodiment as viewed from the mounting face F_{MNT}. Note that in FIG. 4, the opening 12A and the terminal insulating board 12C of the receptacle 12 are indicated by the double-dot-dash lines.

The printed wiring board 11 includes the main substrate 11A and the wire group 11B.

The main substrate 11A is a multilayer board having the mounting face F_{MNT}. The receptacle 12, various components (not shown), and so on are mounted on the mounting face F_{MNT}.

The wire group 11B electrically connects the receptacle 12 and the various components. The wire group 11B transmits digital signals between the receptacle 12 and the various components. The wire group 11B includes multiple lands L, multiple surface wires Wₒᵤₜ, multiple internal wires Wᵢₙ, and multiple ground wires W_{G}.

The multiple lands L are metal members for connecting the terminal group 12D. The multiple lands L include four ground terminal lands L_{G} and eight signal terminal lands L_{S}. The four ground terminal lands L_{G} include ground terminal lands L_{G0}, L_{G1}, L_{G2}, and L_{GC} corresponding to ground terminals T_{G0}, T_{G1}, T_{G2}, and T_{GC}. The eight signal terminal lands L_{S} include signal terminal lands L_{S0+}, L_{S0-}, L_{S1+}, L_{S1-}, L_{S2+}, L_{S2-}, L_{SC+}, and L_{SC-} corresponding to signal terminals T_{S0}, T_{S1}, T_{S2}, and T_{SC}.

Here, the eight signal terminal lands L_{S} are provided closer to the edge portion 11_{EDG} of the main substrate 11A than the four ground terminal lands L_{G}.

The multiple surface wires Wₒᵤₜ are connected to lands other than the ground terminal lands L_{G} and the signal terminal lands L_{S}. Although not shown in the drawings, the surface wires Wₒᵤₜ are connected to the various components.

The multiple internal wires Wᵢₙ are connected to the eight signal terminal lands L_{S} through via wires. The multiple internal wires Wᵢₙ are provided in a predetermined layer (for example, a second layer or the like) within the main substrate 11A. Note that the multiple internal wires Wᵢₙ include internal wires Wᵢₙ₀₊, Wᵢₙ₀₋, Wᵢₙ₁₊, Wᵢₙ₁₋, Wᵢₙ₂₊, Wᵢₙ₂₋, W_{inC+}, and W_{inC-} corresponding to the signal terminal lands L_{S0+}, L_{S0-}, L_{S1+}, L_{S1-}, L_{S2+}, L_{S2-}, L_{SC+}, and L_{SC-}. In this manner, in the present embodiment, all of the wires that correspond to the signal terminals T_{S} are within the layers. Although not shown in the drawings, the internal wires Wᵢₙ are connected to the various components.

Each of the multiple ground wires W_{G} is connected to a respective ground terminal land L_{G} through via wires. The multiple ground wires W_{G} are provided in a predetermined layer (for example, a third layer or the like) within the main substrate 11A. The multiple ground wires W_{G} include ground wires W_{G0}, W_{G1}, W_{G2}, and W_{GC} corresponding to the ground terminal lands L_{G0}, L_{G1}, L_{G2}, and L_{GC}. Although not shown in the drawings, the ground wire groups W_{G} are connected to the various components.

### (Configuration of Ground Terminal T_{G2} and Pair of Signal Terminals T_{S2+} and T_{S2-})

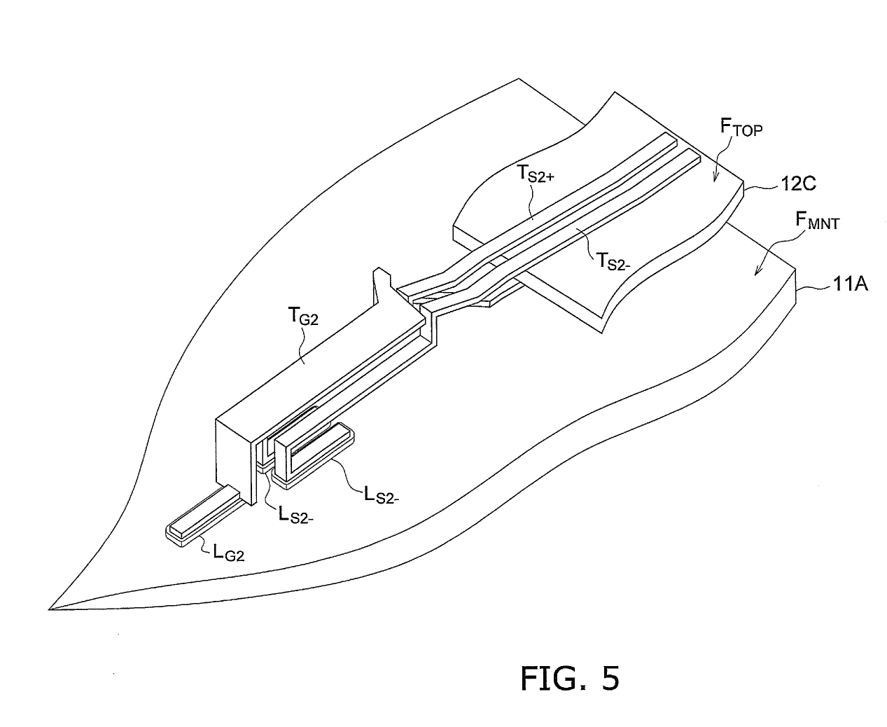

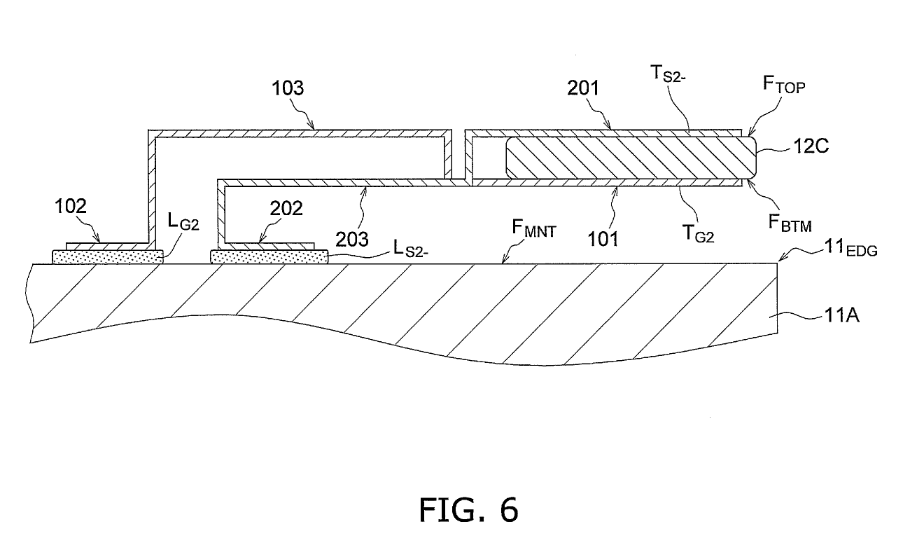

Next, the configuration of the ground terminal T_{G2} and the pair of signal terminals T_{S2+} and T_{S2-} will be described with reference to the drawings. FIG. 5 is a perspective view illustrating the ground terminal T_{G2} and the pair of signal terminals T_{S2+} and T_{S2-}. FIG. 6 is a side view illustrating the ground terminal T_{G2} and the pair of signal terminals T_{S2}+ and T_{S2-}. Note that in FIG. 6, only the signal terminal T_{S2-} of the pair of signal terminals T_{S2+} and T_{S2-} is shown. The signal terminal T_{S2+} has the same configuration as the signal terminal T_{S2-}.

As shown in FIGS. 5 and 6, the ground terminal T_{G2} and the pair of signal terminals T_{S2+} and T_{S2-} both link the bottom face F_{BTM} of the terminal insulating board 12C with the printed wiring board 11.

The ground terminal T_{G2} grounds the pair of signal terminals T_{S2+} and T_{S2-}, and thus is provided along the pair of signal terminals T_{S2+} and T_{S2-}. The ground terminal T_{G2} covers the side of the pair of signal terminals T_{S2+} and T_{S2-} that faces the printed wiring board 11. As a result, a coupled microstrip line whose ground surface is the ground terminal T_{G2} is formed.

As shown in FIG. 6, the ground terminal T_{G2} includes a bottom face connection portion 101, a forward connection portion 102, and a ground terminal linking portion 103.

The bottom face connection portion 101 is connected to the bottom face F_{BTM}. The bottom face connection portion 101 is exposed in the opening 12B (see FIG. 2). The bottom face connection portion 101 makes direct contact with the plug 13 that is inserted into the opening 12B.

The forward connection portion 102 is distanced from the edge portion 11_{EDG} and the opening 12B. The forward connection portion 102 is connected to the ground terminal land L_{G2} through solder or the like.

The ground terminal linking portion 103 links the bottom face connection portion 101 and the forward connection portion 102. The ground terminal linking portion 103 is distanced from the printed wiring board 11 and the terminal insulating board 12C. In other words, the ground terminal linking portion 103 is the portion of the ground terminal T_{G2} that is located in midair (hereinafter called a “midair portion”).

Each terminal in the pair of signal terminals T_{S2+} and T_{S2-} includes, as shown in FIG. 6, a top face connection portion 201, a rearward connection portion 202, and a signal terminal linking portion 203 (note that only the signal terminal T_{S2-} is shown in FIG. 6). Because both terminals in the pair of signal terminals T_{S2+} and T_{S2-} have the same configuration, only the signal terminal T_{S2-} will be described hereinafter.

The top face connection portion 201 is connected to the top face F_{TOP} on the side opposite from the bottom face connection portion 101. The top face connection portion 201 is exposed in the opening 12B (see FIG. 2). The top face connection portion 201 makes direct contact with the plug 13 that is inserted into the opening 12B.

The rearward connection portion 202 is connected to the signal terminal land L_{S2-} through solder or the like. In the present embodiment, the rearward connection portion 202 is bent back toward the edge portion 11_{EDG}.

Here, the rearward connection portion 202 is provided closer to the opening 12B than the forward connection portion 102. Accordingly, the rearward connection portion 202 is connected to the printed wiring board 11 closer to the edge portion 11_{EDG} than the forward connection portion 102.

The signal terminal linking portion 203 links the top face connection portion 201 and the rearward connection portion 202. The signal terminal linking portion 203 is distanced from the printed wiring board 11 and the terminal insulating board 12C. In other words, the signal terminal linking portion 203 is a midair portion of the signal terminal T_{S2-}.

The signal terminal linking portion 203 runs from above the ground terminal linking portion 103 to below the ground terminal linking portion 103. As a result, the vertical positions of the pair of signal terminals T_{S2+} and T_{S2-} and the ground terminal T_{G2} are inverted.

### (Configuration of Ground Terminal T_{G0} and Pair of Signal Terminals T_{S0+} and T_{S0-})

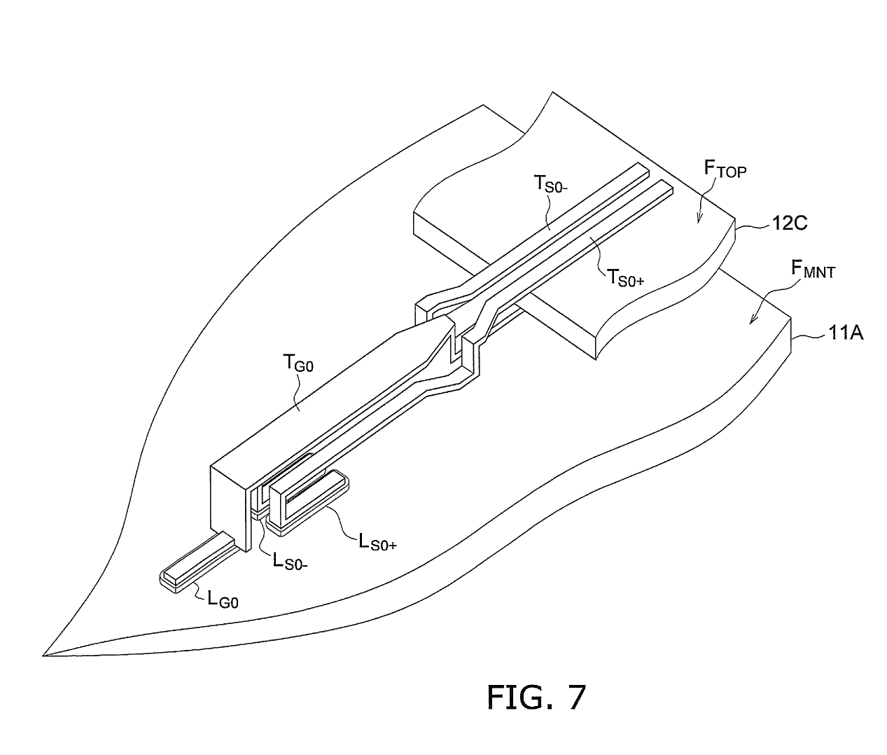

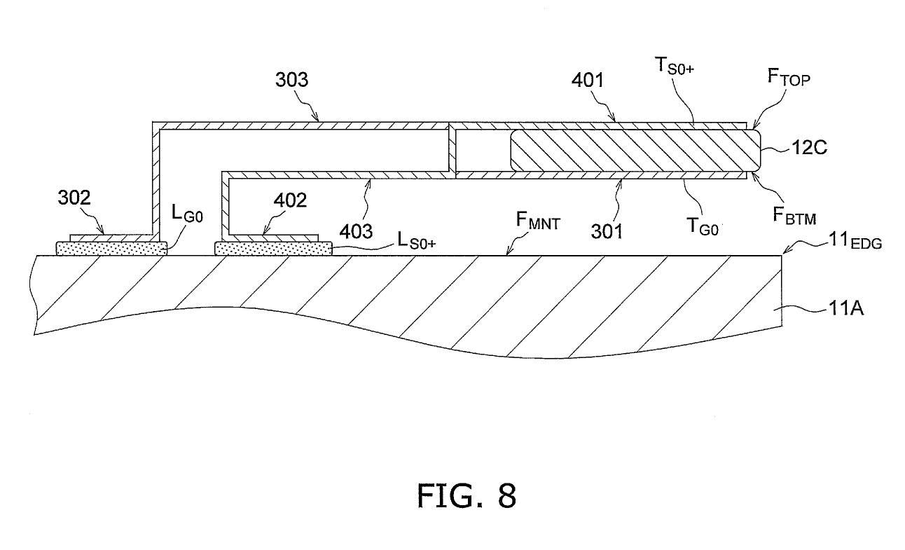

Next, the configuration of the ground terminal T_{G0} and the pair of signal terminals T_{S0+} and T_{S0-} will be described with reference to the drawings. FIG. 7 is a perspective view illustrating the ground terminal T_{G0} and the pair of signal terminals T_{S0+} and T_{S0-}. FIG. 8 is a side view illustrating the ground terminal T_{G0} and the pair of signal terminals T_{S0+} and T_{S)-}. Note that in FIG. 8, only the signal terminal T_{S0+} of the pair of signal terminals T_{S0+} and T_{S0-} is shown. The signal terminal T_{G0} has the same configuration as the signal terminal T_{S0+}.

The ground terminal T_{G0} has the same configuration as the aforementioned ground terminals G₂. The configuration of the pair of signal terminals T_{S0+} and T_{S0-} is the same as the pair of signal terminals T_{S2+} and T_{S2-}.

As shown in FIG. 8, the ground terminal T_{G0} includes a bottom face connection portion 301, a forward connection portion 302, and a ground terminal linking portion 303.

The bottom face connection portion 301 is connected to the bottom face F_{BTM}. The forward connection portion 302 is connected to the ground terminal land L_{G0} through solder or the like. The ground terminal linking portion 303 links the bottom face connection portion 301 and the forward connection portion 302. The ground terminal linking portion 303 is a midair portion of the ground terminal T_{G0}.

Each terminal in the pair of signal terminals T_{S0+} and T_{S0-} includes, as shown in FIG. 8, a top face connection portion 401, a rearward connection portion 402, and a signal terminal linking portion 403 (note that only the signal terminal T_{S0+} is shown in FIG. 8).

The top face connection portion 401 is connected to the top face F_{TOP} on the side opposite from the bottom face connection portion 301.

The top face connection portion 401 is exposed in the opening 12B (see FIG. 2). The top face connection portion 401 makes direct contact with the plug 13 that is inserted into the opening 12B. The rearward connection portion 402 is connected to the signal terminal land L_{S0+} through solder or the like. The rearward connection portion 402 is provided closer to the edge portion 11_{EDG} than the forward connection portion 302.

The signal terminal linking portion 403 links the top face connection portion 401 and the rearward connection portion 402. The signal terminal linking portion 403 is a midair portion of the signal terminal T_{S0+}. The signal terminal linking portion 403 runs from above the ground terminal linking portion 303 to below the ground terminal linking portion 303, and as a result, the vertical positions of the pair of signal terminals T_{S0+} and T_{S0-} and the ground terminal T_{G0} are inverted.

### (Actions and Effects)

(1) In the receptacle 12 according to the first embodiment, the ground terminal T_{G2} includes the bottom face connection portion 101 that is connected to the bottom face Farm of the terminal insulating board 12C and the forward connection portion 102 that is connected to the printed wiring board 11. The signal terminal T_{S2-} includes the top face connection portion 201 that is connected to the top face F_{TOP} on the side opposite from the bottom face connection portion 101 and the rearward connection portion 202 that is connected to the printed wiring board 11 closer to the opening 12B than the forward connection portion 102.

Accordingly, the length of the signal terminal linking portion 203 can be reduced more than in the case where the rearward connection portion 202 is distanced from the opening 12B further than the forward connection portion 102. In other words, the length of the midair portion of the signal terminal T_{S2-}, for which it is difficult to ensure noise resistance, can be reduced. As a result, the noise resistance of the signal terminal T_{S2-}, which is one of the top terminals T_{TOP}, can be improved.

This action and effect is the same in the context of the relationship between the ground terminal T_{G2} and the signal terminal T_{S2+} and the relationship between the ground terminal T_{G0} and the pair of signal terminals T_{S0+} and T_{S0+} as well.
(2) The printed wiring board 11 according to the first embodiment includes the ground terminal land L_{G2} and the signal terminal land L_{S2-}. The signal terminal land L_{S2-} is provided closer to the edge portion 11_{EDG} than the ground terminal land L_{G2} on the mounting face F_{MNT}.

Accordingly, the length of the signal terminal linking portion 203 can be reduced more than in the case where the signal terminal land L_{S2-} is distanced from the edge portion 11_{EDG} further than the ground terminal land L_{G2}. In other words, the length of the midair portion of the signal terminal T_{S2-}, for which it is difficult to ensure noise resistance, can be reduced. As a result, the noise resistance of the signal terminal T_{S2-}, which is one of the top terminals T_{TOP}, can be improved.

This action and effect is the same in the context of the relationship between the ground terminal land L_{G2} and the signal terminal land L_{S2+} and the relationship between the ground terminal land L_{G0} and the pair of signal terminal lands L_{S0+} and L_{S0-} as well.
(3) The printed wiring board 11 according to the first embodiment includes the internal wire Wᵢₙ₂₋, which is formed within the main substrate 11A and is electrically connected to the signal terminal land L_{S2-}.

Accordingly, the amount of wiring formed on the surface of the printed wiring board 11 can be reduced. For this reason, the electromagnetic waves emitted from the printed wiring board 11 can be suppressed more than in the case where surface wires are formed extending from the signal terminal land L_{S2-}. As a result, the EMI (electromagnetic interference) with the various components mounted on the printed wiring board 11 and various devices disposed in the vicinity of the printed wiring board 11 can be reduced.

Furthermore, in the first embodiment, all of the wires corresponding to the signal terminals T_{S} (that is, the internal wires Wᵢₙ) are within layers, and thus the EMI can be reduced even further.

### Second Embodiment

Next, the configuration of a receptacle 12 according to a second embodiment will be described with reference to the drawings. Hereinafter, the differences from the first embodiment will mainly be described. The difference from the first embodiment is that the midair portions of the bottom terminals T_{BTM} are twisted by approximately 90 degrees.

Hereinafter, the configuration of the ground terminal T_{G2}, which is one of the bottom terminals T_{BTM}, will be described as an example. It should be noted, however, that the configuration is not limited to the ground terminal T_{G2}, and the same configuration can be applied to the ground terminal T_{G0} as well.

### Configuration of Ground Terminal T_{G2} and Pair of Signal Terminals T_{S2+} and T_{S2-})

The configuration of the ground terminal T_{G2} and the pair of signal terminals T_{S2+} and T_{S2-} will be described with reference to the drawings.

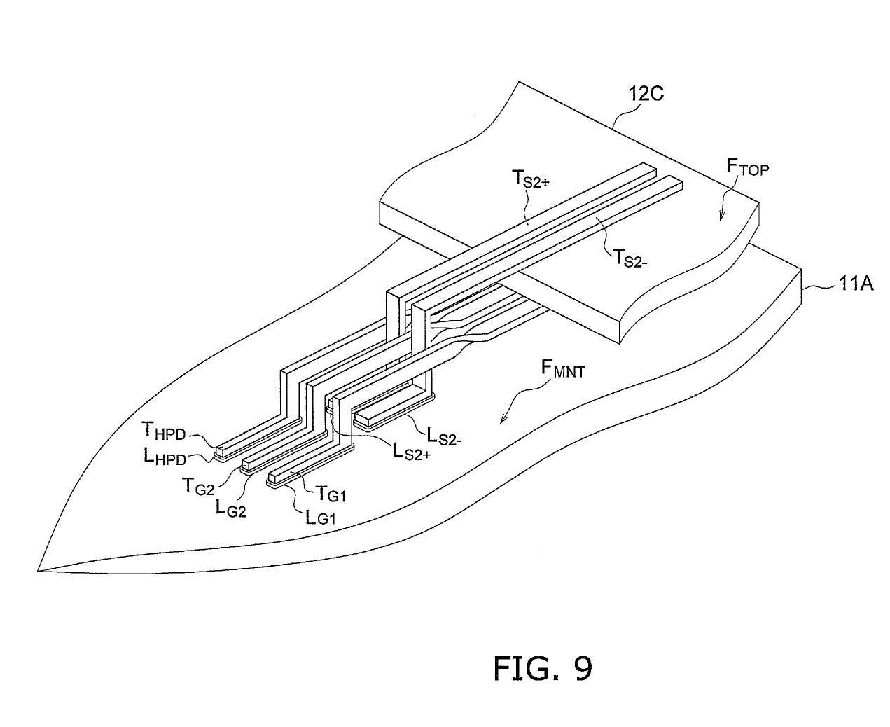

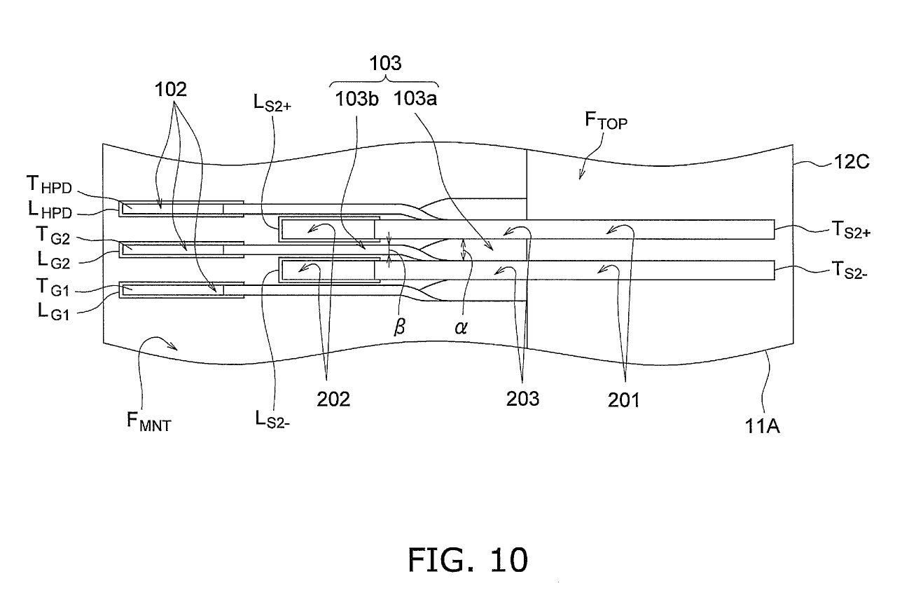

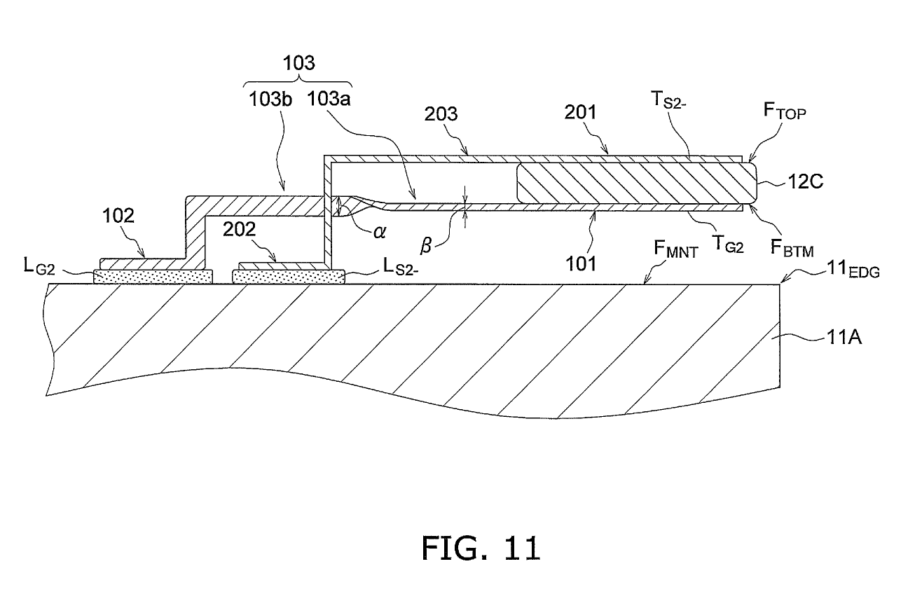

FIG. 9 is a perspective view illustrating the ground terminal T_{G2} and the pair of signal terminals T_{S2+} and T_{S2-}. FIG. 10 is a plan view illustrating the ground terminal T_{G2} and the pair of signal terminals T_{S2+} and T_{S2-} from above the top face F_{TOP}. FIG. 11 is a side view illustrating the ground terminal T_{G2} and the pair of signal terminals T_{S2+} and T_{S2-}. Note that in FIGS. 9 and 10, the configurations of the ground terminal T_{G1} and the HPD signal terminal T_{HPD}, which are adjacent to the ground terminal T_{G2} on the respective sides thereof, are shown. The configurations of the ground terminal T_{G1} and the HPD signal terminal T_{HPD} have been omitted from FIG. 11. In FIG. 11, only the signal terminal T_{S2-} of the pair of signal terminals T_{S2+} and T_{S2-} is shown.

As shown in FIG. 9, the ground terminal T_{G2}, the ground terminal T_{G1}, and the HPD signal terminal T_{HPD} are each twisted by approximately 90 degrees in the midair portions thereof. This increases the interval between terminals.

To be more specific, as shown in FIGS. 10 and 11, the ground terminal T_{G2}, the ground terminal T_{G1}, and the HPD signal terminal T_{HPD} each include a wide portion 103a and a narrow portion 103b.

The wide portion 103a connects to the bottom face connection portion 101. The wide portion 103a extends from the bottom face connection portion 101 to the outer side of the bottom face F_{BTM}. The narrow portion 103b connects to the wide portion 103a. The narrow portion 103b extends from the wide portion 103a toward the forward connection portion 102.

Here, the wide portion 103a and the narrow portion 103b are formed by twisting a plate-shaped metallic piece by approximately 90 degrees. Accordingly, a width a of the wide portion 103a as viewed from above the top face F_{TOP} is equal to a thickness a of the narrow portion 103b as viewed from the side. Furthermore, a thickness β(<α) of the wide portion 103a when viewed from the side is equivalent to a width β of the narrow portion 103b when viewed from above. Accordingly, when viewed from the top face F_{TOP}, the width β of the narrow portion 103b is narrower than the width α of the wide portion 103a.

Each of the terminals in the pair of signal terminals T_{S2+} and T_{S2-} is disposed adjacent to the narrow portion 103b. In other words, the signal terminal T_{S2+} and the signal terminal T_{S2-} are disposed symmetrically, with the narrow portion 103b therebetween. As a result, the vertical positions of the pair of signal terminals T_{S2+} and T_{S2-} and the ground terminal T_{G2} are inverted.

Meanwhile, in the present embodiment, the ground terminal T_{G1} and the HPD signal terminal T_{HPD} each have the same configuration as the ground terminal T_{G2}. The signal terminal T_{S2+} is disposed between the narrow portion 103b of the ground terminal T_{G1} and the narrow portion 103b of the ground terminal T_{G2}. The signal terminal T_{S2-}, meanwhile, is disposed between the narrow portion 103b of the HPD signal terminal T_{HPD} and the narrow portion 103b of the ground terminal T_{G2}.

### (Actions and Effects)

(1) In the receptacle 12 according to the second embodiment, the ground terminal T_{G2} includes the wide portion 103a and the narrow portion 103b. When viewed from the top face F_{TOP}, the width β of the narrow portion 103b is narrower than the width a of the wide portion 103a.

Accordingly, it is easier to secure space for disposing the signal terminal T_{S2-} next to the narrow portion 103b. As a result, the ground terminal T_{G2} and the signal terminal T_{S2-} can be disposed in what is a linear manner when viewed from above. Accordingly, it is easier to achieve a simplified terminal structure.
(2) In the receptacle 12 according to the second embodiment, the ground terminal T_{G1} that is connected to the bottom face F_{BTM} and is adjacent to the ground terminal T_{G2} has the same configuration as the ground terminal T_{G2}.

Accordingly, it is easier to secure space for disposing the signal terminal T_{S2-} between the ground terminal T_{G1} and the ground terminal T_{G2}. For this reason, the terminal structure can be further simplified.

### Third Embodiment

Next, the configuration of a receptacle 12 according to a third embodiment will be described with reference to the drawings. Hereinafter, the differences from the first embodiment will mainly be described. The difference from the first embodiment is that the vertical positions of the ground terminal T_{G2} and the signal terminal T_{S2-} are inverted within the terminal insulating board 12C.

### (Receptacle Configuration)

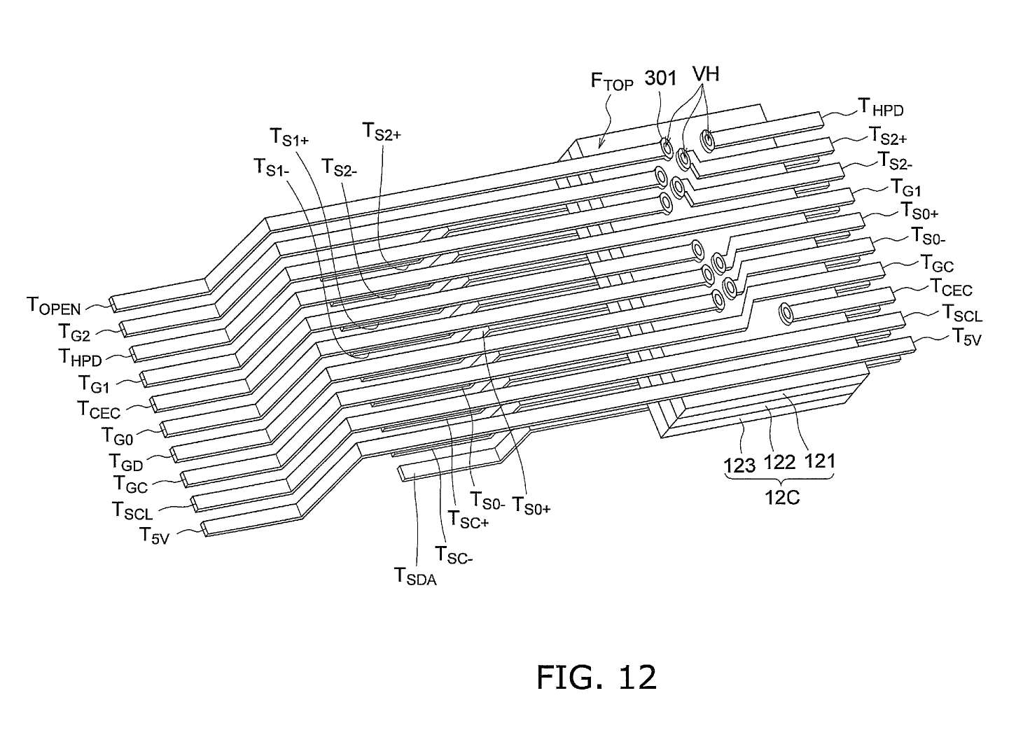

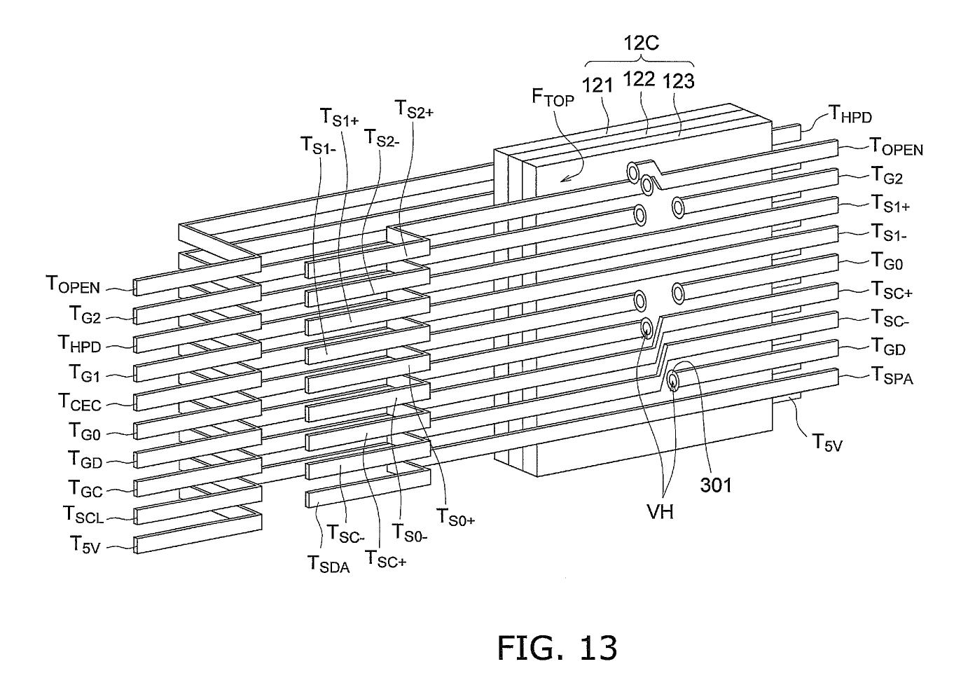

The configuration of the receptacle 12 according to the third embodiment will be described with reference to the drawings. FIG. 12 is a perspective view illustrating the receptacle 12 according to the third embodiment as viewed from the top face F_{TOP}. FIG. 13 is a perspective view illustrating the receptacle 12 according to the third embodiment as viewed from the bottom face F_{BTM}. Note that the housing 12A has been omitted from FIGS. 12 and 13.

The terminal insulating board 12C is configured of three substrates that are stacked (a top substrate 121, a middle substrate 122, and a bottom substrate 123). Each of the three substrates has multiple via holes VET formed therein in a predetermined pattern. The inner walls of the multiple via holes VH are plated with a conductive material. As a result, via wires 301 are formed.

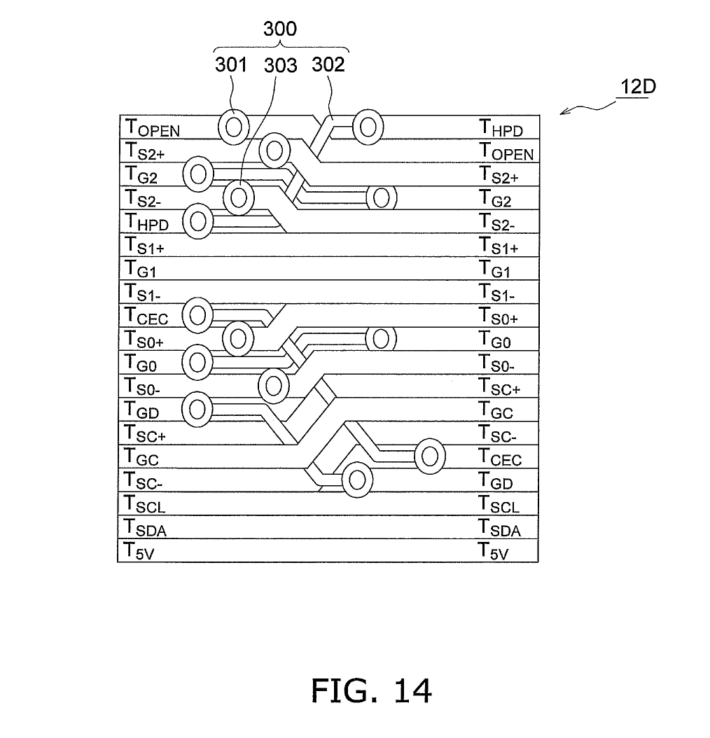

Here, FIG. 14 is a transparent view illustrating the terminal insulating board 12C as viewed from the top face F_{TOP}. As shown in FIG. 14, the terminal group 12D has multiple inner layer portions 300. Each inner layer portion 300 includes a via wire 301, an inner layer wire 302, and an inner layer wire 303.

The via wire 301 passes through at least one of the top substrate 121, the middle substrate 122, and the bottom substrate 123.

The inner layer wire 302 is aimed between the top substrate 121 and the middle substrate 122. The inner layer wire 302 is connected to two via wires 301.

The inner layer wire 303 is formed between the middle substrate 122 and the bottom substrate 123. The inner layer wire 303 is connected to two via wires 301.

### (Configuration of Ground Terminal T_{G2} and Signal Terminal T_{S2-})

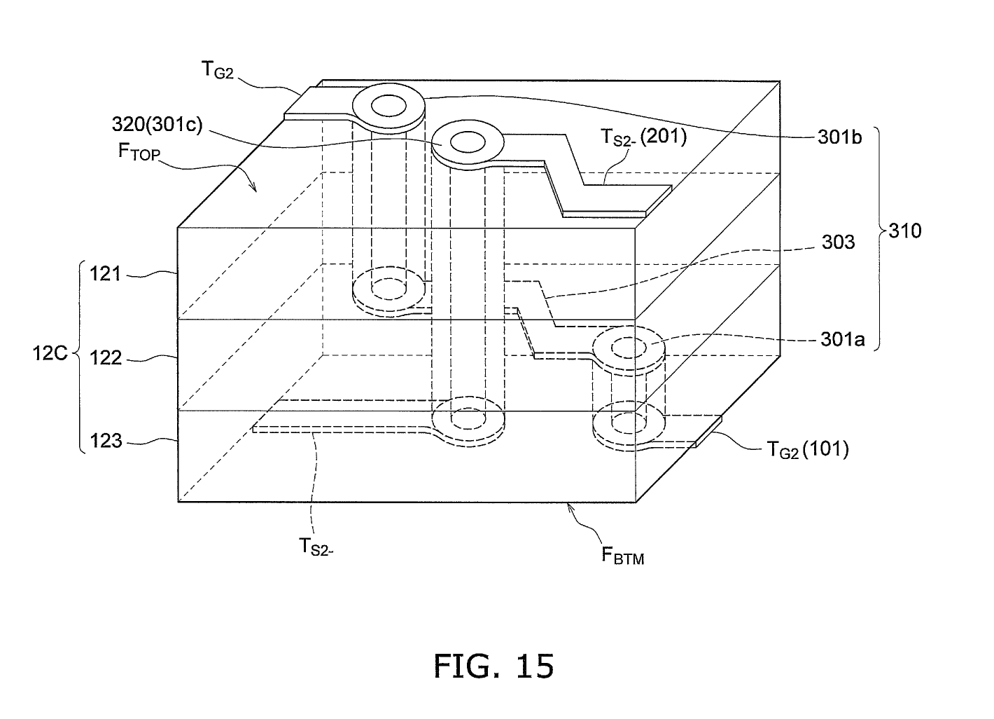

Next, the configuration of the ground terminal T_{G2} and the signal terminal T_{S2-} will be described with reference to the drawings. FIG. 15 is a see-through perspective view of the terminal insulating board 12C illustrating the configuration of the ground terminal T_{G2} and the signal terminal T_{S2-}.

The ground terminal T_{G2} includes the bottom face connection portion 101 and a first inner layer portion 310. The first inner layer portion 310 is connected to the bottom face connection portion 101 on the bottom face F_{BTM}. The first inner layer portion 310 passes through the terminal insulating board 12C from the bottom face F_{BTM} to the top face F_{TOP}.

The first inner layer portion 310 is configured of a first via wire 301a, a second via wire 301b, and the inner layer wire 303. The first via wire 301a is connected to the bottom face connection portion 101 on the bottom face F_{BTM}. The first via wire 301 a passes through the bottom substrate 123. The second via wire 301b passes through the top substrate 121 and the middle substrate 122. The inner layer wire 303 is formed between the middle substrate 122 and the bottom substrate 123. The inner layer wire 303 connects the first via wire 301a and the second via wire 301b.

The signal terminal T_{S2-} includes the top face connection portion 201 and a second inner layer portion 320. The second inner layer portion 320 is connected to the top face connection portion 201 on the top face F_{TOP}. The second inner layer portion 320 passes through the terminal insulating board 12C from the top face F_{TOP} to the bottom face F_{BTM}. The second inner layer portion 320 is configured of a third via wire 301c that passes through the top substrate 121, the middle substrate 122, and the bottom substrate 123.

As a result, the vertical positions of the signal terminal T_{S2-} and the ground terminal T_{G2} are inverted within the terminal insulating board 12C.

### (Actions and Effects)

In the receptacle 12 according to the third embodiment, the ground terminal T_{G2} includes the first inner layer portion 310, and the signal terminal T_{S2-} includes the second inner layer portion 320. The first inner layer portion 310 is connected to the bottom face connection portion 101 on the bottom face F_{BTM} and passes through the terminal insulating board 12C from the bottom face F_{BTM} to the top face F_{TOP}. The signal terminal T_{S2-} is connected to the top face connection portion 201 on the top face F_{TOP} and passes through the terminal insulating board 12C from the top face F_{TOP} to the bottom face F_{BTM}.

In this manner, the vertical positions of the signal terminal T_{S2-} and the ground terminal T_{G2} are inverted within the terminal insulating board 12C, and thus it is not necessary for the signal terminal T_{S2-} and the ground terminal T_{G2} to intersect at their midair portions. For this reason, the terminal structure with respect to the signal terminal T_{S2-} and the ground terminal T_{G2} can be simplified.

### Other Embodiments

Although the present invention has been described according to the aforementioned embodiments, it is to be understood that the descriptions and drawings of which this disclosure is made up are not intended to limit the invention. Various alternative embodiments, working examples, and operational techniques should be clear to a person skilled in the art based on this disclosure.
(1) Although in the aforementioned embodiments, the terminal insulating board 12C does not overlap with the forward connection portion 102 and the rearward connection portion 202 when viewed from above, the configuration is not limited thereto. The terminal insulating board 12C may overlap with at least one of the forward connection portion 102 and the rearward connection portion 202 when viewed from above.
(2) Although the aforementioned embodiments have described an interface based on the HDMI standard as an example of an interface between electronic devices, the present invention is not limited to this interface. For example, a serial interface based on a standard such as USB (Universal Serial Bus), DVI (Digital Visual Interface)®, or IEEE (Institute of Electrical and Electronic Engineers) 1394 can be used as the interface between the electronic devices.
(3) Although the aforementioned embodiments have described the signal terminals TS as transmitting signals according to a quasi-differential transmission system based on TMDS or the like, the present invention is not limited thereto. For example, the signal terminals TS may transmit signals according to a differential transmission system based on the USB standard.
(4) Although the aforementioned embodiments have described the structure of the terminal group 12D using the drawings, the structure of the terminal group 12D is not limited to that illustrated in the drawings. Various design alterations can be made on the structure of the terminal group 12D.
(5) Although not particularly discussed in the aforementioned embodiments, the widths of the signal terminals T_{S}, the widths of the ground terminals T_{G}, and the distances between the signal terminals T_{S} and the ground terminals T_{G} can be set as appropriate. Doing so makes it possible to adjust the characteristic impedance of the lines.

Thus it goes without saying that the present invention includes various other embodiments not described here. Accordingly, the technical scope of the present invention is to be defined only by the invention-defining matters according to the scope of claims pursuant to the above descriptions.

### INDUSTRIAL APPLICABILITY

According to the receptacle, the printed wiring board, and the electronic device of the present embodiment, the noise resistance of signal terminals in the top terminals can be improved, and thus the present invention is useful in the field of electronic devices.

What is claimed is:

1. A receptacle comprising:
a housing configured to be mounted on a printed wiring board, the housing defining an opening into which a plug is inserted;
a terminal insulating board including a top face and a bottom face opposite the top face, the terminal insulating board being disposed inside the housing with the bottom face facing the printed wiring board;
a ground terminal including a bottom face connection portion connected to the bottom face and a forward connection portion configured to be connected to the printed wiring board; and
a signal terminal including a top face connection portion connected to the top face and disposed opposite to the bottom face connection portion and a rearward connection portion configured to be connected to the printed wiring board at a position closer to the opening than the forward connection portion.

2. The receptacle according to claim 1, wherein the ground terminal includes a wide portion disposed between and connecting a narrow portion and the bottom face connection portion, the width of the narrow portion being smaller than the width of the wide portion when viewed from the top; and the signal terminal is disposed lateral to the narrow portion.

3. The receptacle according to claim 1,
wherein the ground terminal further includes a first inner layer portion connected to the bottom face connection portion on the bottom face of the terminal insulating board, the first inner layer portion being inserted into the terminal insulating board from the bottom face to the top face, and
the signal terminal further includes a second inner layer portion connected to the second top face connection portion on the top face of the terminal insulating board, the second inner layer portion being inserted into the terminal insulating board from the top face through to the bottom face.

4. The receptacle according to claim 3,
wherein the terminal insulating board is a stack of substrates formed of at least one substrate, and each of the first inner layer portion and the second inner layer portion includes a via wire inserted into the stack of substrates.

5. A printed wiring board configured to fixedly support a receptacle that includes a terminal insulating board having a top face and a bottom face opposite the top face, a ground terminal connected to the bottom face, and a signal terminal connected to the top face, the printed wiring board comprising:
a main substrate including a mounting face configured to fixedly support the receptacle, the main substrate being disposed below the bottom face of the terminal insulating board;
a ground terminal land mounted on the mounting face and configured to be connected to the ground terminal; and
a signal terminal land mounted on the mounting face at a position closer to an edge of the main substrate than the ground terminal land, the signal terminal land configured to be connected to the signal terminal.

6. The printed wiring board according to claim 5, further comprising
an internal wire disposed within the main substrate and electrically connected to the signal terminal land.

7. An electronic device comprising:
a receptacle; and a printed wiring board,
the receptacle including
a housing defining an opening which is inserted, the housing being mounted on the printed wiring board,
a terminal insulating board including a top face and a bottom face opposite the top face, the terminal insulating board being disposed inside the housing with the bottom face facing the printed wiring board,
a ground terminal including a bottom face connection portion connected to the bottom face and a forward connection portion connected to the printed wiring board, and
a signal terminal including a top face connection portion connected to the top face and disposed opposite to the bottom face connection portion and a rearward connection portion connected to the printed wiring board, and
the printed wiring board including
a main substrate having a mounting face that fixedly supports the receptacle, the main substrate being disposed below the bottom face of the terminal insulating board,
a ground terminal land mounted on the mounting face and connected to the rearward connection portion, and
a signal terminal land mounted on the mounting face at a position closer to an edge of the main substrate than the ground terminal land, the signal terminal land being connected to the rearward connection portion.
